(19) United States
(12) Patent Application Publication
(10) Pub. No.: US 2024/0307823 A1
(43) Pub. Date: Sep. 19, 2024

(54) NANOFILTRATION SYSTEM AND METHOD

(71) Applicant: BL TECHNOLOGIES, INC., Minnetonka, MN (US)

(72) Inventors: Jianwen ZHAI, Beijing (CN); Xiaojun XU, Shanghai (CN); Linglu YANG, Shanghai (CN)

(21) Appl. No.: 18/572,638

(22) PCT Filed: Jun. 30, 2022
(86) PCT No.: PCT/US2022/035757

§ 371 Date: Dec. 20, 2023

(30) Foreign Application Priority Data
Jul. 8, 2021 (CN) 202110772265.3

(51) Int. Cl. B01D 61/02; B01D 71/56

(52) U.S. Cl. CPC B01D 61/0271; B01D 61/029; B01D 71/56; B01D 2257/30; B01D 2311/2512; B01D 2325/20

(57) ABSTRACT

A multistage nanofiltration (NF) system for filtering a solute from a feed solution where a downstream NF stage is more permissive to the solute than an upstream NF stage. In some examples. the nanofiltration system includes a plurality of nanofiltration stages in series, where each nanofiltration stage is more permissive to the solute than the nanofiltration stage that is immediately upstream.

### CROSS-REFERENCE TO RELATED APPLICATIONS

This application claims the benefit of Chinese Application Serial No. 202110772265.3, filed Jul. 8, 2021, which is incorporated herein by reference.

### FIELD

The present disclosure relates to nanofiltration systems and methods.

### BACKGROUND

The following paragraphs are not an admission that anything discussed in them is prior art or part of the knowledge of persons skilled in the art.

Membrane separation processes concentrate a solute in an aqueous solution by the application of a positive pressure to one side of a filtration membrane. A membrane separation process treats a feed stream solution and produces a portion as a permeate solution and the remainder as a retentate solution. The concentration of the solute in the permeate solution is reduced in comparison to the concentration of the solute in the feed stream. The concentration of the solute in the retentate solution is increased in comparison to the concentration of the solute in the feed stream. The retentate solution may alternatively be referred to as a concentrate solution. Different separation membranes can separate and concentrate different solutes.

Examples of such processes are reverse osmosis (RO), microfiltration (MF), ultrafiltration (UF) and nanofiltration (NF). Nanofiltration uses membranes with nanometer-sized pores. Nanofiltration membranes have pore sizes that are smaller than microfiltration and ultrafiltration membranes, but larger reverse osmosis membranes. Nanofiltration membranes may have pores with pore sizes from 1-10 nanometers.

### INTRODUCTION

The following introduction is intended to introduce the reader to this specification but not to define any invention. One or more inventions may reside in a combination or sub-combination of the system elements or method steps described below or in other parts of this document. The inventors do not waive or disclaim their rights to any invention or inventions disclosed in this specification merely by not describing such other invention or inventions in the claims.

At high concentrations of solute, the permeate recovery of a nanofiltration system having a single type of nanofiltration membrane may be undesirably low and/or may require undesirable operating conditions. For example, treatment of an aqueous feed stream that has 25 to 27 wt % of H₂SO₄ and 25 to 35 g/L of ferrous sulfate in a nanofiltration system having a single type of nanofiltration membrane at optimized operating conditions can result in a 40% recovery of the sulfate. In another example, a nanofiltration system having a single type of nanofiltration membrane for treating a sodium sulfate (Na₂SO₄) solution may need to be operated at an undesirably high pressure, such as 120 bars, to achieve >220 g/L concentration in the retentate, necessary to qualify as a zero liquid discharge (ZLD) process.

One or more described examples attempt to address or ameliorate one or more shortcomings involved with nanofiltration systems and methods that use a single type of nanofiltration membrane.

In one aspect, the present disclosure provides a multi-stage nanofiltration system for filtering a solute from a feed solution where downstream nanofiltration stages are more permissive to the solute than upstream nanofiltration stages.

In some examples, the nanofiltration system includes a plurality of nanofiltration stages in series, where each nanofiltration stage is more permissive to the solute than the nanofiltration stage that is immediately upstream.

In some examples, the present disclosure provides a nanofiltration system that includes a first nanofiltration stage that produces a retentate and a permeate; and a second nanofiltration stage that produces a retentate and a permeate. The second nanofiltration stage is downstream of the first nanofiltration stage and accepts at least a portion of the retentate from the first nanofiltration stage. The second nanofiltration stage is more permeable to a solute than the first nanofiltration stage.

In another aspect, the present disclosure provides a method of filtering a solute from a feed solution. The method includes successive nanofiltration steps, where each subsequent nanofiltration step is more permissive to the solute than the previous nanofiltration step.

In some examples, the present disclosure provides a method of filtering a solute from a feed solution. The method includes treating the feed solution to a first nanofiltration process to produce a first permeate and a first retentate, treating at least a portion of the first retentate to a second nanofiltration process to produce a second permeate and a second retentate. The second nanofiltration process uses a nanofiltration member that is more permeable to the solute than the nanofiltration membrane used in the first nanofiltration process.

Nanofiltration systems and methods according to the present disclosure may be operated with the NF stages at substantially the same pressure.

### BRIEF DESCRIPTION OF THE DRAWINGS

Embodiments of the present disclosure will now be described, by way of example only, with reference to the attached Figures.

FIG. 1 is a schematic process flow diagram of a nanofiltration system according to the present disclosure.

FIG. 2 is a schematic process flow diagram of another nanofiltration system according to the present disclosure.

### DETAILED DESCRIPTION

Generally, the present disclosure provides a multistage nanofiltration (NF) system and method for filtering a solute from a feed solution.

In a nanofiltration system according to the present disclosure, the downstream NF stages are more permissive to the solute than the upstream NF stages. In some examples, the nanofiltration system includes a plurality of nanofiltration stages in series, where each nanofiltration stage is more permissive to the solute than the nanofiltration stage that is immediately upstream.

The permissiveness of an NF stage may be quantified based on the percent rejection of the solute. A more permissive stage rejects less of the solute than a less permissive stage. The percent rejection may be determined by comparing the concentration of the solute in a permeate stream to the concentration of the solute in the feed stream. If, for example, 5% of the solute from the feed stream passes through the stage into the permeate stream, then the stage is 5% permissive to that solute. The stage may, alternatively, be referred to as having a solute rejection of 95%. A more permissive stage would be a stage that allows more than 5% of the solute from the feed stream to pass through the stage.

A nanofiltration stage may include a plurality of nanofiltration membranes, such as in a spiral wound membrane module. When all of the NF membranes in an NF stage are the same, the NF stage has the same permissiveness as the membranes.

Permissiveness of an NF stage depends on what solute is being evaluated. For example, an NF stage may be 5% permissive of sulfate ions, but 99% permissive of chloride ions. In the context of the present disclosure, permissiveness of different NF stages is in comparison to a single solute of interest. For example, in a nanofiltration system for removing sulfate ions from a feed stream, an upstream NF stage may be 5% permissive of sulfate ions and a downstream NF stage may be 20% permissive of sulfate ions, irrespective of the relative permissiveness for other solutes, such as chloride ions.

In the context of the present disclosure, NF stages may be identified by number, where the number corresponds to the relative arrangement from upstream to downstream. For example, a “second NF stage” (NF2) should be understood to be downstream of a “first NF stage” (NF1) with no intervening nanofiltration stages; and a “third NF stage” (NF3), if present, would be understood to be downstream of the second NF stage with no intervening nanofiltration stages. Process equipment other than nanofiltration stages may be included between the nanofiltration stages. For example, a pump, a tank, on-line chemical dosing equipment, filtration equipment, or any combination thereof could be installed between nanofiltration stages to achieve a desired pressure, temperature, pH, or turbidity, or to dose in a desired chemical. In some exemplary systems, there is no process equipment between the nanofiltration stages. Operating such a system may result in energy savings and/or a simpler process.

In some examples, the permissiveness of the first NF stage is 15% or less (that is, the first NF stage may have a solute rejection of 85% or more). In some examples, the permissiveness of the second NF stage is 5% or more (that is, the second NF stage may have a solute rejection of 95% or less). In some examples, the permissiveness of a third NF stage is 5% or more (that is, the third NF stage may have a solute rejection of 95% or less). In some examples, the difference between the permissiveness of the first and the second NF stages may be from 5% to 70%.

It should be understood that, in the context of the present disclosure, any disclosure of a contemplated range of values is also a disclosure of any value or subrange within the recited range, including endpoints. For example, a contemplated rate of “15% or less” is also a disclosure of, for example: 1%, 2.5%, 10%, 2% to 15%, 4% to 8%, and 2% to 6%.

Despite the overlapping ranges referred to above (for example, permissiveness of NF1 can be 15% or less, and permissiveness of NF2 can be 5% or more) it should be understood that a downstream NF stage must still be more permissive to the solute than the previous NF stages. Accordingly, for example, when the permissiveness of NF1 is 10%, the permissiveness of NF2 must be more than 10%. If such an exemplary system included NF3, the permissiveness of the NF3 must be more than the permissiveness of NF2.

In an example with two NF stages, the first NF stage may have a solute permissiveness of 5% or less; the second NF stage may have a solute permissiveness of 15% or more, such as about 30%; and the difference between the permissiveness of the first and second NF stages may be from 10% to 70%. In a specific example, the first NF stage may have a solute permissiveness of 3%, and the second NF stage may have a solute permissiveness of 50%, resulting in a permissiveness difference of 47%.

In an example with three NF stages, the first NF stage may have a solute permissiveness of 5% or less; the second NF stage may have a solute permissiveness of 5% or more, such as 10% or more; and the third NF stage may have a solute permissiveness of 5% or more, such as 20% or more. In an example with three NF stages, the first NF stage may have a solute permissiveness of 1%to 5%; the second NF stage may have a solute permissiveness of 5% to 15%; and the third NF stage may have a solute permissiveness of 20% to 60%. In another example with three NF stages, the first NF stage may have a solute permissiveness of 1% to 5%; the second NF stage may have a solute permissiveness of 5% to 15%; and the third NF stage may have a solute permissiveness of 40 %to 60%.

One specific exemplary system according to the present disclosure is a 2-stage nanofiltration system where the solute is FeSO₄, the NF1 has a permissiveness of about 5% and the NF2 has a permissiveness of about 30%. Such a system may be accept a feed solution that includes Fe at 25 g/L in H₂SO₄.

Another specific exemplary system according to the present disclosure is a 3-stage nanofiltration system where the solute is Na₂SO₄ or Li₂SO₄, the NF1 has a permissiveness of about 1%, the NF2 has a permissiveness of about 10%, and the NF3 has a permissiveness of about 50%. Such a system may be accept a feed solution that includes Na₂SO₄ at 100 g/L, or Li₂SO₄ at 78 g/L.

An NF stage that is immediately downstream of another NF stage would be understood to configured to accept at least a portion of the retentate from the NF stage that is immediately upstream. The NF systems according to the present disclosure may be configured as a continuously high pressure concentration array. For example, the concentrate solution produced by an upstream NF stage may be directly fed to the subsequent downstream NF stage, with substantially no pressure loss between the two NF stages. However, it should be understood that reference to “immediately downstream” and “immediately upstream” does not preclude the possibility that process equipment other than nanofiltration stages is included between the nanofiltration stages. In particular examples, that process equipment does not result in substantial pressure loss between the two NF stages.

NF systems according to the present disclosure may include two, three, or more NF stages. The NF systems may include a recycle stream that returns at least a portion of the permeate from a downstream NF stage (for example from a second NF stage) to an inlet of an upstream NF stage (for example to a first NF stage). In NF systems with three NF stages, the system may include a recycle stream that returns at least a portion of the permeate from the third NF stage to an inlet of the first NF stage, or to an inlet of the second NF stage.

An NF stage may include a thin-film composite (TFC) NF membrane. The thin-film composite NF membrane may be a polyamide or a non-polyamide TFC membrane. The NF membrane may have a molecular weight cutoff (MWCO) from 150 to 3500 g/mol, such as from 150 to 350 g/mol, from 500 to 3500 g/mol, or from 500 to 2500 g/mol. In some examples, the NF membrane of NF1 has a MWCO of 150 to 350 g/mol; and the NF membrane of NF2 has a MWCO of more 350 g/mol, such as from 500 to 3500 g/mol. The

MWCO of NF3 may be higher than the MWCO of NF2, and the MWCO of NF2 may be higher than the MWCO of NF1.

Specific examples of suitable NF membranes include Suez 1812 NF elements, which are thin film composite membranes having a MWCO of 150-300. Different stages could include membranes from the same product family, with different solute permissiveness. For example, one NF stage could include a Suez 1812 NF element having a solute permissiveness of 3%; and a downstream NF stage could include a Suez 1812 NF element having a solute permissiveness of 45%. Two examples of a Suez 1812 NF element were used in the Examples, discussed below. In one, the NF membrane was a polyamide thin-film composite nanofiltration membrane having a sodium sulfate retention rate of 97% and an MgSO₄ retention rate >98% at 2000 ppm MgSO₄, 110psi, 25° C. In the other, the NF membrane was a non-polyamide thin-film composite nanofiltration membrane having a sodium sulfate retention rate of 80% to 95% and an MgSO₄ retention rate of 80% to 95% at 2000 ppm MgSO₄, 110 psi, 25° C.

In some examples, the present disclosure provides a nanofiltration system that includes a first nanofiltration stage that produces a retentate and a permeate; and a second nanofiltration stage that produces a retentate and a permeate. The second nanofiltration stage is downstream of the first nanofiltration stage and accepts at least a portion of the retentate from the first nanofiltration stage. The second nanofiltration stage is more permeable to a solute than the first nanofiltration stage.

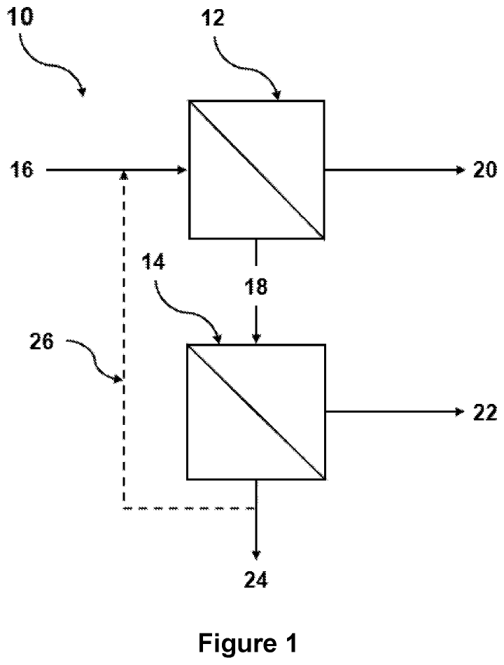

FIG. 1 illustrates an exemplary nanofiltration system according to the present disclosure. Nanofiltration system 10 includes a first nanofiltration stage 12, and second nanofiltration stage 14. The first NF stage 12 accepts feed 16 and produces a retentate 18 and a permeate 20. The second NF stage 14 accepts at least a portion of the retentate 18. The second NF stage 14 includes nanofiltration membranes (not shown) that make the second NF stage 14 more permeable to a solute than the first NF stage 12. The second NF stage 14 produces a retentate 22 and a permeate 24. The illustrated NF system 10 includes an optional recycle stream 26 that returns at least a portion of the permeate 24 to an inlet of the first NF stage 12.

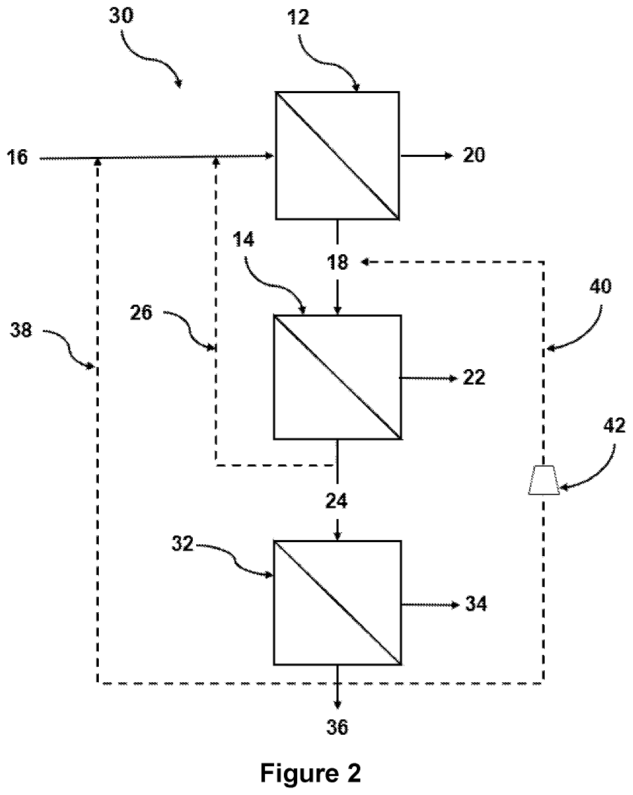

FIG. 2 illustrates an exemplary nanofiltration system according to the present disclosure. The nanofiltration system 30 includes the same features as the nanofiltration system 10 illustrated in FIG. 1, and so uses the reference numbers for the common features. The nanofiltration system 30 additionally includes a third NF stage 32. The third NF stage 32 produces a retentate 34 and a permeate 36. The third NF stage 32 includes nanofiltration membranes (not shown) that make the third NF stage 32 more permeable to the solute than the first NF stage 12, and optionally more permeable to the solute than the second NF stage 14.

The illustrated NF system 30 includes an optional recycle stream 38 that returns at least a portion of the permeate 36 to an inlet of the first NF stage 12. Such an optional recycle stream would be suitable for a system that operated to produce permeate 36 with a solute concentration that was similar to the solute concentration entering the first NF stage 12.

The illustrated NF system 30 includes an optional recycle stream 40 that returns at least a portion of the permeate 36 to an inlet of the second NF stage 14. Such an optional recycle stream would be suitable for a system that operated to produce permeate 36 with a solute concentration that was higher than the solute concentration entering the first NF stage 12. A system that includes optional recycle stream 40 may additionally include a high pressure inter-stage pump 42.

In another aspect, the present disclosure provides a method of filtering a solute from a feed solution. The method includes treating the feed solution in a first nanofiltration process to produce a first permeate and a first retentate, and treating at least a portion of the first retentate in a second nanofiltration process to produce a second permeate and a second retentate, where the second nanofiltration process rejects the solute at a lower rate than the first nanofiltration process. A portion of the second permeate may be recycled back to the first nanofiltration process. Optionally, the method may also include treating at least a portion of the second retentate in a third nanofiltration process, where the third nanofiltration process rejects the solute at a lower rate than the first nanofiltration process, and optionally at a lower rate than the second nanofiltration process.

In some exemplary methods, the first NF process may be permissive to 15% or less of the solute (that is, the first NF process may reject 85% or more of the solute). In some exemplary methods, the second NF process may be permissive to 5% or more (that is, the second NF process may reject 95% or less of the solute). In some examples, the third NF process may be permissive to 5% or more (that is, the third NF process may reject 95% or less of the solute). In some examples, the difference between the permissiveness of the first and the second NF processes may be from 5% to 70%.

As discussed above with respect to the nanofiltration system, despite the overlapping ranges referred to above, it should be understood that a downstream NF process must still be more permissive to the solute than the upstream NF processes. Accordingly, for example, when the first NF process filters 90% of the solute (that is, the process is permissive to 10% of the solute), the second NF process must filter less than 90% of the solute (that is, the process must be permissive to more than 10% of the solute).

In an exemplary method with two NF processes, the first NF process may reject more than 95% of the solute; the second NF process may reject 85% or less, such as about 70%; and the difference between the rejection rate the first and second NF processes may be from 10% to 70%. In a specific example, the first NF process may reject 97% of the solute, and the second NF process may reject 50% of the solute, resulting in a difference of 47%.

In an example with three NF processes, the first NF process may reject 95% or more; the second NF process may reject 95% or less, such as 90% or less; and the third NF stage may reject 95% or less, such as 80% or less. In an exemplary method with three NF processes, the first NF process may reject 99% to 95% of the solute; the second NF process may reject 95% to 85% of the solute; and the third NF process may reject 80% to 40% of the solute. In another exemplary method with three NF processes, the first NF process may reject 99% to 95% of the solute; the second NF process may reject 95% to 85% of the solute; and the third NF process may reject 60% to 40% of the solute.

One specific exemplary process according to the present disclosure is a 2-stage nanofiltration process that accepts a solution containing FeSO₄, treats the solution in a first NF process that retains about 95% of the solute, and in a second NF process that retains about 70%of the solute. The feed solution may include Fe at 25 g/L in H₂SO₄.

Another specific exemplary process according to the present disclosure is a 3-stage nanofiltration process that accepts a solution containing Na₂SO₄ or Li₂SO₄, treats the solution in a first NF process that retains about 99% of the solute; in a second NF process that retains about 90% of the solute; and in a third NF process that retains about 50%of the solute. The feed solution may include Na₂SO₄ at 100 g/L, or Li₂SO₄ at 78 g/L.

NF systems and methods according to the present disclosure may be configured to treat solutions that include as the solute of interest: (i) sulfate, such as in a solution that includes sodium sulfate (Na₂SO₄), lithium sulfate (Li₂SO₄), aluminum sulfate (Al₂(SO₄)₃), ferrous sulfate (FeSO₄), and/or sulfuric acid (H₂SO₄); or (ii) a soluble organic molecule, such a molecule present in the bio-effluent of a landfill leachate, for example a molecule with a molecular weight between 100 g/mol and 3500 g/mol.

When the solute of interest is sulfate, the feed solution may have a sulfate concentration of 5 g/L to 200 g/L. The feed solution may be, for example: a titanium dioxide waste stream, such as a waste steam with 25-30 wt % H₂SO₄ and at least 45 g/L of Fe ion; an aluminum electroplate waste stream, such as a waste stream with about 25 wt % H₂SO₄ and at least 10 g/L of Al ion; or a solution with soluble sodium or lithium sulfate salts at a concentration of at least 100 g/L of Na₂SO₄, or at least 80 g/L of Li₂SO₄.

In particulate examples, the initial feed solution may include sodium sulfate at a concentration of 10 to 250 g/L, and the system or method may be operated at a feed pressure of 10 to 250 bar. In a system or method with three NF stages or processes, the total dissolved solids for the sodium sulfate may be: (a) from 100 to 200 g/L, such as 150 to 200 g/L, in the retentate of the first stage or process; and (b) from 100 to 350 g/L, such as from 150 to 300 g/L, in the retentate of the second and/or third stage or process.

When the solute of interest is a soluble organic compound, the solution may have an organic compound concentration of 3 to 10 g/L.

### EXAMPLES

Exemplary nanofiltration systems according to the present disclosure were

modeled. The following tables illustrate the modeled flows and solute concentrations of the system illustrated in FIG. 1, where all of the NF1 retentate is transferred to NF2; and all of the NF2 permeate is recycled to NF1. This results in the NF1 feed being the combination of the System feed and the NF2 permeate.

TABLE 1
Modeled NF system and method

| | Flow | Fe | H₂SO₄ |
|---|---|---|---|
| | rate | concentration | concentration |
| | (m³/h) | (g/L) | (g/L) |
| System feed (16) | 30 | 33 | 300.0 |
| NF1 feed (16 + 26) | 41.4 | 31.6 | 301.1 |
| NF1 retentate (18) | 22.8 | 56.7 | 276.5 |
| NF1 permeate (20) | 18.6 | 1.0 | 331.3 |
| NF2 retentate (22) | 11.4 | 85.4 | 248.9 |
| NF2 permeate (26) | 11.4 | 28.0 | 304.2 |

In the modeled nanofiltration system for Table 1, the NF1 stage has a 45% recovery (that is, 45% of the feed water becomes permeate), rejects 97% of the Fe, and rejects −10% of the H₂SO₄; and the NF2 stage has a 50% recovery, rejects 50% of the Fe, and rejects −10% of the H₂SO₄.

TABLE 2
Modeled NF system and method

| | Flow | Al | H₂SO₄ |
|---|---|---|---|
| | rate | concentration | concentration |
| | (m³/h) | (g/L) | (g/L) |
| System feed (16) | 20 | 12 | 300 |
| NF1 feed (16 + 26) | 28 | 10.85 | 307 |
| NF1 retentate (18) | 15 | 19.85 | 293 |
| NF1 permeate (20) | 12.4 | 0.5 | 337 |
| NF2 retentate (22) | 7 | 33.4 | 260 |
| NF2 permeate (26) | 8 | 8 | 323 |

In the modeled nanofiltration system for Table 2, the NF1 stage has a 45% recovery, rejects 95% of the Al, and rejects −10% of the H₂SO₄; and the NF2 stage has a 50% recovery, rejects 60% of the Al, and rejects −10% of the H₂SO₄.

TABLE 3
Modeled NF system and method

| | Flow rate | TDS concentration |
|---|---|---|
| | (m³/h) | (g/L) |
| System feed (16) | 100 | 50 |
| NF1 feed (16 + 26) | 120 | 52.2 |
| NF1 retentate (18) | 40 | 155.5 |
| NF1 permeate (20) | 80.2 | 0.5 |
| NF2 retentate (22) | 20 | 248 |
| NF2 permeate (26) | 20 | 63 |

In the modeled nanofiltration system for Table 3, the NF1 stage has a 67% recovery, and rejects 99% of the total dissolved solids (TDS); and the NF2 stage has a 50% recovery, and rejects 60% of the TDS.

Two NF stages, corresponding to NF1 and NF2, were tested at 900 psi using different amounts of total dissolved solids of Na₂SO₄ in the feed. The NF1 stage used a polyamide thin-film composite nanofiltration membrane having a sodium sulfate retention rate of 97% and an MgSO₄ retention rate >98%@2000 ppm MgSO₄, 110psi, 25° C., and the NF2 stage used a non-polyamide thin-film composite nanofiltration membrane having a sodium sulfate retention rate of 80% to 95% and an MgSO₄ retention rate of 80% to 95%@2000 ppm MgSO₄, 110psi, 25° C.

It was determined that, when the feed was 100 g/L of sodium sulfate, the NF1 stage could produce a permeate at an acceptable flux of 4.51 LMH (liters/m²/h) and a retentate at 175 g/L of sodium sulfate. Producing a retentate with higher concentrations of sodium sulfate resulted in an unacceptably high osmotic pressure difference, and an unacceptably reduced permeate flux. The NF2 stage, at the same feed concentration and pressure (100 g/L of sodium sulfate and 900 psi), could produce a permeate of 175 g/L at a flux of 14.5 LMH, which means that the NF2 stage could further concentrate the retentate produced by the NF1 stage at the same operating pressure.

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

1. A nanofiltration system comprising:
a first nanofiltration stage that produces a retentate and a permeate; and
a second nanofiltration stage that produces a retentate and a permeate, wherein the second nanofiltration stage is downstream of the first nanofiltration stage and accepts at least a portion of the retentate from the first nanofiltration stage,
wherein the second nanofiltration stage is more permeable to a solute than the first nanofiltration stage.

2. The nanofiltration system according to claim 1, further comprising a recycle stream that returns at least a portion of the permeate from the second nanofiltration stage to an inlet of the first nanofiltration stage.

3. The nanofiltration system according to claim 1, wherein the solute is a sulfate, and the first nanofiltration stage comprises an inlet for a sulfate-containing feed solution, such as a sodium sulfate (Na2SO4) feed solution, an aluminum sulfate (Al2(SO4)3) feed solution, or an iron sulfate (FeSO4) feed solution; or the solute is a soluble organic molecule, and the first nanofiltration stage comprises an inlet for an organic molecule-containing feed solution.

4. The nanofiltration system according to claim 3, wherein the sulfate-containing solution entering the system has a sulfate concentration of 5 g/L to 200 g/L.

5. The nanofiltration system according to claim 1, wherein
the first nanofiltration stage has a solute rejection of at least 85%, such as from 95%to 99%; and the second nanofiltration stage has a solute rejection of up to 95%, such as from 85% to 95%, or from 50% to 85%; optionally the difference between the rejection of the first and the second NF stages is from 5% to 70%;
for example, wherein the first nanofiltration stage has a solute rejection of about 95%, and the second nanofiltration stage has a solute rejection of about 70%.

6. The nanofiltration system according to claim 1, wherein
the first nanofiltration stage comprises a polyamide thin-film composite nanofiltration membrane having a molecular weight cutoff of 150 to 350 g/mol; and/or the second nanofiltration stage comprises a non-polyamide thin-film composite nanofiltration membrane having a molecular weight cutoff of 500 to 3500 g/mol.

7. The nanofiltration system according to claim 1, further comprising a third nanofiltration stage that produces a retentate and a permeate,
wherein the third nanofiltration stage is downstream of the second nanofiltration stage and accepts the retentate from the second nanofiltration stage, and
wherein the third nanofiltration stage is more permeable to the solute than the first nanofiltration stage.

8. The nanofiltration system according to claim 7, wherein the third nanofiltration stage is more permeable to the solute than the second nanofiltration stage.

9. The nanofiltration system according to claim 7, wherein the third nanofiltration stage has a solute rejection of at least 5%, such as from about 20% to about 80%, for example from about 40% to about 60%,
for example wherein the first nanofiltration stage has a solute rejection of about 99%, the second nanofiltration stage has a solute rejection of about 90%, and the third nanofiltration stage has a solute rejection of about 50%.

10. The nanofiltration system according to claim 6, wherein the third nanofiltration stage comprises a non-polyamide thin-film composite nanofiltration membrane having a molecular weight cutoff of 500 to 3500 g/mol.

11. The nanofiltration system according to claim 7, further comprising one or more recycle streams that return at least a portion of the permeate from the third nanofiltration stage to an inlet of the first nanofiltration stage and/or an inlet of the second nanofiltration stage.

12. A method of filtering a solute from a feed solution, the method comprises:
treating the feed solution to a first nanofiltration process to produce a first permeate and a first retentate,
treating at least a portion of the first retentate to a second nanofiltration process to produce a second permeate and a second retentate, wherein the second nanofiltration process uses a nanofiltration member that is more permeable to the solute than the nanofiltration membrane used in the first nanofiltration process.

13. The method according to claim 12, further comprising recycling at least a portion of the second permeate back to the first nanofiltration process.

14. The method according to claim 12, wherein
the solute is a sulfate and the feed solution is a sulfate-containing feed solution, such as a sodium sulfate (Na2SO4) feed solution, an aluminum sulfate (Al2(SO4)3) feed solution, or an iron sulfate (FeSO4) feed solution; or
the solute is a soluble organic molecule, and the feed solution is an organic molecule-containing feed solution.

15. The method according to claim 12, wherein the sulfate-containing solution entering the system has a sulfate concentration of 5 g/L to 200 g/L.

16. The method according to claim 12, wherein
the nanofiltration membrane used in the first nanofiltration process has a solute rejection of at least 85%, such as from about 95% to about 99%; and the nanofiltration membrane used in the second nanofiltration process has a solute rejection of up to 95%, such as from about 85% to about 95%, or from 50% to 85%, optionally wherein the difference between the rejection of the membranes used in the first and the second NF processes is from 5% to 70%;
for example, wherein the nanofiltration membrane used in the first nanofiltration process has a solute rejection of about 95%, and the nanofiltration membrane used in the second nanofiltration process has a solute rejection of about 70%, optionally for treating a solution containing FeSO4.

17. The method according to claim 12, further comprising treating at least a portion of the second retentate to a third nanofiltration process to produce a third permeate and a third retentate,
wherein the third nanofiltration process uses a nanofiltration membrane that is more permeable to the solute than the nanofiltration membrane used in the first nanofiltration process,
optionally recycling at least a portion of the third permeate back to the first nanofiltration process, the second nanofiltration process, or both.

18. The method according to claim 17, wherein the nanofiltration membrane used in the third nanofiltration stage is more permeable to the solute than the nanofiltration membrane used in the second nanofiltration process.

19. The method according to claim 17, wherein the nanofiltration membrane used in the third nanofiltration process has a solute rejection of at least 5%, such as about 20% to about 80%, for example from about 40% to about 60%, for example wherein the nanofiltration membrane used in the first nanofiltration process has a solute rejection of about 99%, the nanofiltration membrane used in the second nanofiltration process has a solute rejection of about 90%, and the nanofiltration membrane used in the third nanofiltration process has a solute rejection of about 50%, optionally for treating a solution containing Na₂SO₄ or Li₂SO₄.

20. A method of filtering a solute from a feed solution, the method comprises successive nanofiltration steps, wherein each subsequent nanofiltration step is more permissive to the solute than the previous nanofiltration step.

21. The method according to claim 12, wherein the nanofiltration stages are at substantially the same pressure.
